(19) United States
(12) Patent Application Publication
(10) Pub. No.: US 2011/0157645 A1
(43) Pub. Date: Jun. 30, 2011

(54) IMAGE FORMING APPARATUS, METHOD FOR CONTROLLING IMAGE FORMING APPARATUS, AND STORAGE MEDIUM

(75) Inventor: Toshihisa Okutsu, Kawasaki-shi (JP)

(73) Assignee: CANON KABUSHIKI KAISHA, Tokyo (JP)

(21) Appl. No.: 12/974,985

(22) Filed: Dec. 21, 2010

(30) Foreign Application Priority Data
Dec. 24, 2009 (JP) 2009-292837

(51) Int. Cl. G06F 3/12

(52) U.S. Cl. 358/1.15

(57) ABSTRACT

An image forming apparatus to communicate through a USB interface with an information processing apparatus and an operation unit. The image forming apparatus includes a change unit, a first determination unit, and a second determination unit. The change unit changes a connection state between a state in which the image forming apparatus as a USB host is connected to the operation unit as a USB device and a state in which the information processing apparatus as a USB host is connected to the operation unit as a USB device. When it is possible to communicate with the information processing unit through the USB interface and the information processing apparatus can control the operation unit, the change unit changes a connection state from a connection between the image forming apparatus (host) and the operation unit (device) to a connection between the information processing apparatus (host) and the operation unit (device).

### BACKGROUND OF THE INVENTION

1. Field of the Invention

The present invention relates to an image forming apparatus to communicate through a universal serial bus (USB) interface with an information processing apparatus and an operation unit.

2. Description of the Related Art

In a personal computer environment, a USB interface generally is used to connect a computer with a peripheral device such as a mouse and a printer. Conventionally, to reduce the load of processing that a printer executes, a technique to execute image formation processing of print data by a host computer connected with a printer main body is generally known. In such a processing system, the image formation processing of the print data is performed in a host computer main body utilizing the processing capacity of the host computer and only the data subjected to image formation processing is handled on the printer side. This technique allows achieving high printing output even if processing performance is curtailed to be low on the printer main body side.

In regards to the USB interface as a standard, the USB interface is classified into a USB host that controls a communication partner through the USB interface, and a USB device that is controlled by the partner. It is determined that one USB host manages the entire control. The mouse or the printer functions as a USB device that complies with the USB host.

Furthermore, the USB interface maybe used as not only connection between a personal computer and the peripheral device thereof but also a communication unit inside a device such as a printer. For example, a USB interface enables communication between a main controller and an operation unit inside a printer. In such a configuration, a USB host controller is equipped on a main controller of a printer and a USB device controller is equipped on an operation unit. Thus, the printer as the USB host controls the operation unit as the USB device.

In Japanese Patent Application Laid-Open No. 2008-071346, a technique is discussed in which image data processing is distributed and executed corresponding to the processing capacity or the transfer performance of each of an image processing apparatus and a host apparatus. When the distributed processing described in the above-described conventional technique is executed, it is conceivable that a host computer connected through the USB interface executes also processing other than image formation processing among processing to be executed by a printer. For example, the host computer performs display control of the operation unit equipped on the printer. Specifically, since moving image formation to display a moving image in order to describe the operation of a printer is processing that requires high load, the host computer instead deals with the processing.

A printer is connected to a host computer which is a USB host as a USB device and further to an operation unit which is a USB device as a USB host. At this time, when causing the host computer to control the operation unit, it will always go through a hardware source such as a printer, a memory, or a central processing unit (CPU). Owing to the bottleneck thereof, anticipated high speed processing may not be accomplished. In other words, when the load of the CPU on the printer is high due to printing processing other than display processing, the display processing cannot be executed at a high speed.

### SUMMARY OF THE INVENTION

The embodiments are directed to suppressing occurrence of a bottleneck that becomes a problem when an information processing apparatus connected to an image forming apparatus such as a printer through a USB interface controls an operation unit on the printer.

An image forming apparatus to communicate through a universal serial bus (USB) interface with an information processing apparatus and an operation unit. The image forming apparatus includes a change unit, a first determination unit, and a second determination unit. The change unit changes a connection state between a state in which the image forming apparatus as a USB host is connected to the operation unit as a USB device and a state in which the information processing apparatus as a USB host is connected to the operation unit as a USB device. The first determination unit determines whether it is possible to communicate with the information processing unit through the USB interface. The second determination unit determines whether the information processing apparatus can control the operation unit. When both the first determination unit determines it is possible to communicate with the information processing unit through the USB interface and the second determination unit determines that the information processing apparatus can control the operation unit, the change unit changes a first connection state in which the image forming apparatus as a USB host is connected to the operation unit as a USB device to a second connection state in which the information processing apparatus as a USB host is connected to the operation unit as a USB device.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a system configuration and an internal hardware configuration of a printer according to the present exemplary embodiment.

FIG. 2 illustrates the hardware configuration of a host personal computer (PC) according to the present exemplary embodiment.

FIG. 3 illustrates the software configuration of a host PC according to the present exemplary embodiment.

FIG. 4 illustrates a USB connection state when a printer main body controls an operation unit.

FIG. 5 illustrates a USB connection state when a host PC controls an operation unit.

FIG. 6 is a diagram illustrating a sequence between a host PC and a printer.

FIG. 7 is a flowchart illustrating processing flow to be executed by a printer according to the present exemplary embodiment.

FIG. 8 is a flowchart illustrating processing flow to be executed by a host PC according to the present exemplary embodiment.

### DESCRIPTION OF THE EMBODIMENTS

Various exemplary embodiments, features, and aspects of the invention will be described in detail below with reference to the drawings.

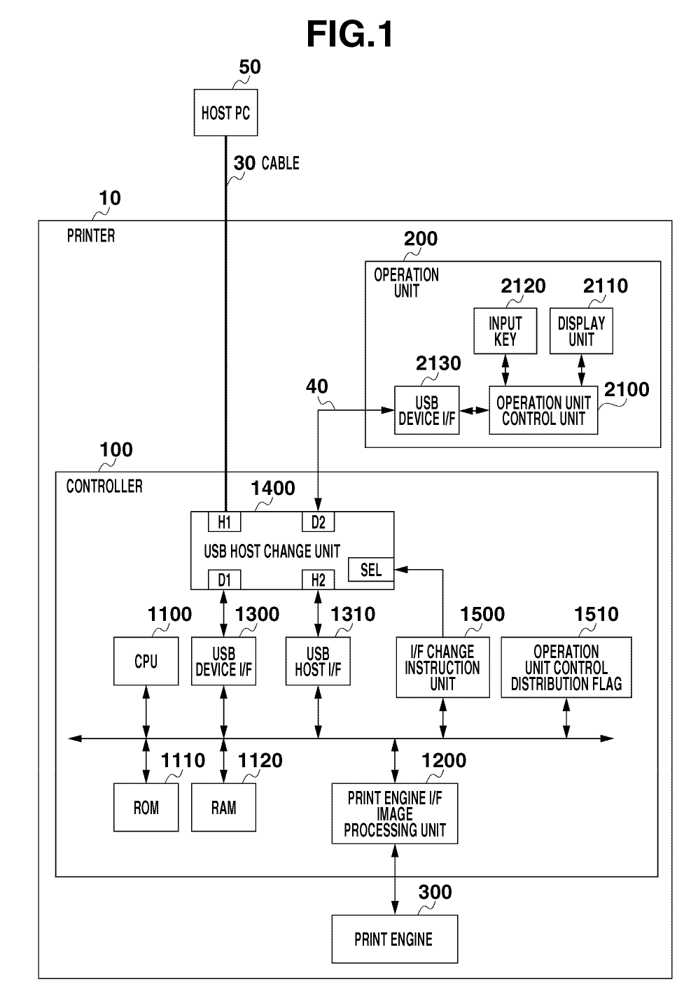

FIG. 1 illustrates a system configuration and an internal hardware configuration of a printer according to the present exemplary embodiment.

In the present exemplary embodiment, a printer 10 as an image forming apparatus and a host PC 50 as an information processing apparatus are connected with a USB interface cable 30. The inside of the printer 10 is configured by a controller 100, an operation unit (operation unit) 200, and a print engine 300. The printer 10 receives print data transmitted from the host PC 50. The controller 100 processes it. The print engine 300 outputs it on a sheet as print output. Further, the operation unit 200 executes various settings on the printer 10 and displays the state of the printer. The controller 100 and the operation unit 200 are connected through a USB interface 40.

The internal configuration of the controller 100 will be described below. A central processing unit (CPU) 1100 is a controller to control the entire system. A random access memory (RAM) 1110 is a system work memory for operation of the CPU 1100 and also an image memory for temporarily storing image data. A read only memory (ROM) 1120 is a program storage ROM and stores a boot program of a system and a system application. A print engine interface (I/F) 1200 is connected with the print engine 300 and both communicate with a CPU of the print engine 300 respectively. Further, the print engine interface (I/F) 1200 executes synchronous/asynchronous conversion of image data.

Referring to FIG. 1, the configuration of a USB interface inside a printer in the present exemplary embodiment will be described. A USB device I/F 1300 is an interface to communicate with the host PC 50 through a USB interface. Print data generated by the host PC 50 is received via this interface. A USB host I/F 1310 communicates with the operation unit 200. When the controller 100 controls the operation unit 200, the CPU 1100 controls the operation unit 200 through this interface. An I/F change instruction unit 1500 is a unit configured to change the connection state of a USB host change unit 1400 which will be described below. An operation unit control distribution flag 1510 is a unit configured to retain information (value of flag) that indicates whether to cause a host computer to control the operation unit 200. When the retention value of the operation unit control distribution flag is “false”, it indicates that the controller 100 on the printer 10 controls the operation unit 200. On the other hand, when the retention value of the operation unit control distribution flag is “true”, it indicates that the host PC 50 controls the operation unit 200.

The USB host change unit 1400 executes change control of the connection state of host/device of a USB interface. Specifically, it is configured to connect two host devices to H1 and H2 illustrated in FIG. 1 and connect device equipment to D1 and D2 (H denotes host and D denotes device). Connection between the host device and the device equipment can be changed by SEL indicated in FIG. 1. In the present exemplary embodiment, the I/F change instruction unit 1500 instructs change. Specifically, by giving an instruction to SEL, the connection state is changed. A method of change will be described below referring to a flowchart and the connection state will be described below referring to a connection state diagram.

The internal hardware configuration of the operation unit in the present exemplary embodiment will be described referring to FIG. 1. The operation unit 200 includes an input key 2120 and a display unit 2110. The operation unit 200 allows an operator of a printer to display state of a device and make settings of a device. An operation unit control unit 2100 controls the entire operation unit and includes a USB device I/F 2130 as a communication unit. The image data and the state of a device to be displayed on the display unit are acquired through the USB device I/F 2130. In the present exemplary embodiment, the USB host I/F 1310 equipped on the controller 100 or the host PC 50 serves as a partner of communication on a USB, corresponding to the state of the USB change unit 1400. The connection state will be described below referring to a connection state diagram.

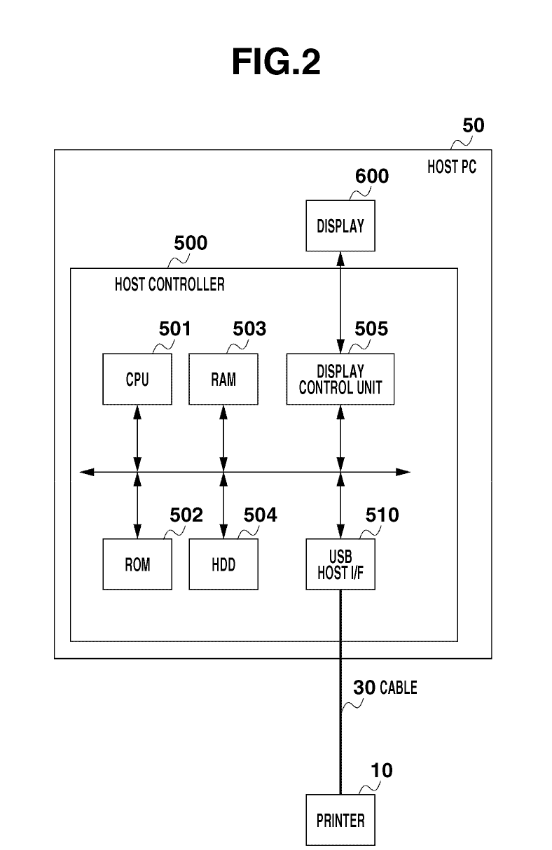

FIG. 2 illustrates the hardware configuration of the host PC 50 according to the present exemplary embodiment. A host controller 500 is connected with a display 600, and a keyboard and a mouse (not illustrated). On the other hand, the host controller 500 communicates with the printer 10 via the USB interface cable 30. A CPU 501 is a controller to control the entire system. The CPU 501 integrates and controls various types of processing to be executed inside the controller. A ROM 502 is a boot ROM and stores a boot program of a system. A RAM 503 is a system work memory for operation of the CPU 501. Further, the RAM 503 is used as an image memory to temporarily store image data such as print data and, in an example, stores moving image data to be displayed on the operation unit. A hard disk drive (HDD) 504 can store system software and image data. In an example, the HDD 504 particularly stores moving image data showing a device operation method to be displayed on the operation unit 200 of the printer 10. As an example of the moving image data that indicates the device operation method, moving image data as guidance indicating an operation to remove a paper jam when the paper jam occurs on a printer is considered. A display control unit 505 outputs image data to be displayed on the display 600 to the display 600. A USB host I/F 510 is a control unit of a keyboard and a mouse (not illustrated), and an input and output I/F with the printer 10.

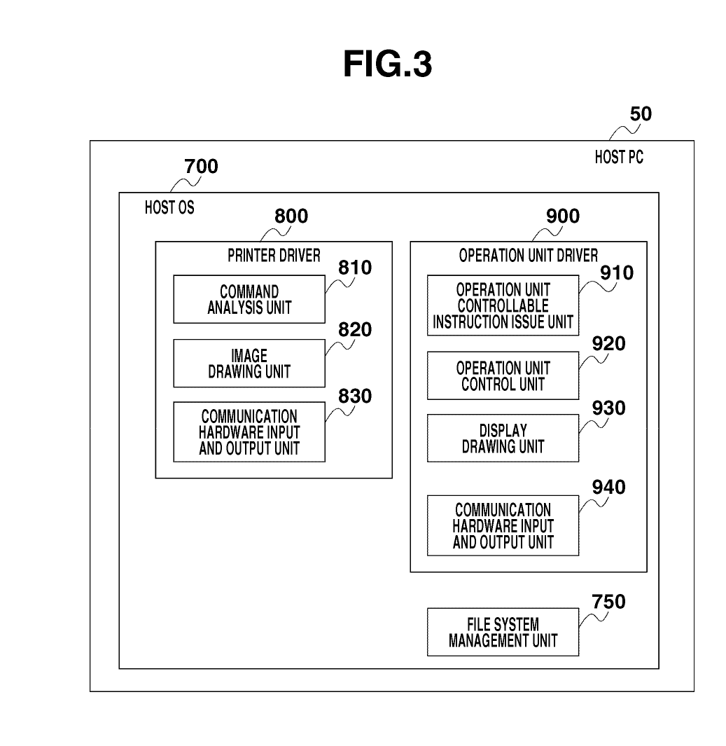

FIG. 3 illustrates the software configuration of the host PC 50 according to the present exemplary embodiment. A host operating system (OS) 700 controls the entire device. A feature portion is a file system management unit 750, a printer driver 800 for controlling a printer via the USB host I/F 510, and an operation unit driver 900 for controlling the operation unit. These types of software are stored in a storage unit such as the ROM 502 and the HDD 504 on the host PC and are executed by the CPU 501.

The file system management unit 750 manages a file system on the host PC 50 and a HDD inside a device as a file system. In the present exemplary embodiment, the file system management unit 750 manages moving image data that the operation unit driver displays on the operation unit.

The printer driver 800 includes a command analysis unit 810 configured to analyze a print command, an image drawing unit 820 configured to execute image drawing processing to execute image formation based on the analyzed print command, and a communication hard input and output unit 830 configured to execute hard control of the USB host I/F 510. In the above-described configuration, data for printing after undergoing from analysis of the print command to image formation is transmitted to the printer 10 through the USB host I/F.

The operation unit driver 900 includes an operation unit controllable instruction issue unit 910 configured to indicate to a printer that the host PC 50 can control the operation unit 200 on the printer 10, an operation unit control unit 920 configured to execute input control and display control of the operation unit, a drawing display unit 930 configured to execute drawing processing of moving image data acquired from the file system management unit 750 as display data, and the communication hard input and output unit 830 configured to execute hard control of the USB host I/F 510. In the above-described configuration, an instruction is given that the operation unit 200 on the printer 10 can be controlled, and the entire control processing of the operation unit can be executed. In particular, as its feature, display data is drawn according to moving image data and communication is performed with the printer 10 via the USB host I/F.

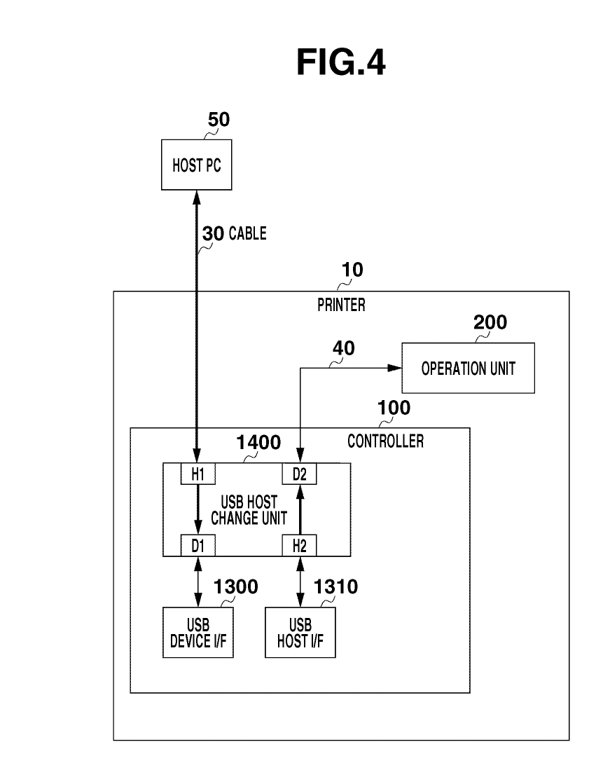

In the present exemplary embodiment, FIG. 4 illustrates a USB connection state (first connection state) when a printer main body controls the operation unit 200. FIG. 4 illustrates the connection state where the host PC 50 does not control the operation unit 200 just after the power source on the printer 10 is started up, for example. Specifically, when the USB host change unit is connected, H1 and D1 are directly connected, and H2 and D2 are directly connected. More particularly, it is in a state in which the printer 10 (controller 100) as a USB device is connected to the host PC 50 as a USB host and on the other hand, the operation unit 200 as a USB device is connected to the printer 10 (controller 100) as a USB host. By this connection state, inside the printer 10, the controller 100 and the operation unit 200 are connected through the USB interface 40, and the controller 100 directly controls the operation unit 200. On the other hand, the host PC 50 and the printer 10 are also connected with the USB interface cable 30. Thus, the printer 10 can receive print data and an instruction that the host PC 50 described below can control the operation unit 200, from the host PC 50 via the USB interface cable 30.

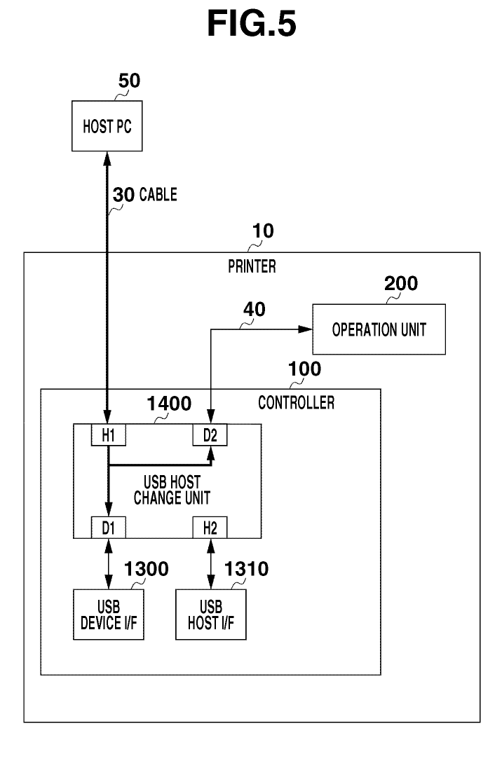

FIG. 5 illustrates a USB connection state (second connection state) of a case in which the host PC 50 controls the operation unit 200. In this connection state, the host PC 50 and the operation unit 200 are directly connected through a USB interface without being relayed by a printer main body (relay of controller 100 on printer 10). This allows the host PC 50 to directly transfer data such as moving image data, which is needed to be transmitted to the operation unit 200, to the operation unit 200. A problem of a bottleneck due to relay of the printer main body can be solved. Specifically, in the connection state of the USB host change unit, H1 is directly connected to D1 and D2. More particularly, it is in a state in which the printer 10 (controller 100) as a USB device is connected to the host PC 50 as a USB host and further the operation unit 200 as a USB device is connected to the host PC 50 as a USB host. By this connection state, the host PC 50 is connected with the controller 100 and the operation unit 200 inside the printer 10 through the USB interface. In this state, since it is not necessary to connect the USB host I/F 1310 on the controller 100 and the operation unit 200, H2 and D2 are not connected.

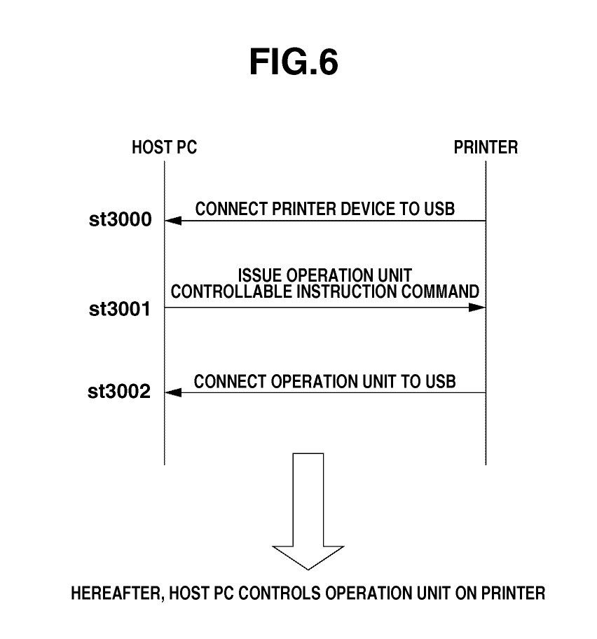

FIG. 6 is a sequence diagram illustrating the exchange between the host PC 50 and the printer 10 until the host PC 50 controls the operation unit 200. The content of processing between the host PC 50 and the controller 100 on the printer main body, and then the host PC 50 and the operation unit 200 on the printer main body will be described.

This sequence is executed when the state of the USB interface between the host PC 50 and the printer 10 is changed. Specifically, the sequence is executed when a USB interface cable is newly connected, or a power source on the printer 10 or the host PC 50 is started up.

When physical cable connection or start-up of a power source on a device is executed between the host PC 50 and the printer 10, in step st3000, a connection state is established between the printer 10 and the host PC 50 through the USB interface. At this time, the host PC 50 operates as a USB host and the printer 10 operates as a USB device. Accordingly, the connection state of the USB host change unit 1400 on the printer 10 is in the first connection state (printer main body-operation unit control mode) illustrated in FIG. 4. Next, in step st3001, the host PC 50 transmits an operation unit controllable instruction command to the printer 10 through the USB interface. More particularly, the host PC 50 notifies the printer 10 that the operation unit 200 equipped on the printer 10 can be controlled. Next, in step st3002, the printer 10 changes the connection state of the USB host change unit 1400 into the second connection state (host PC-operation unit control mode) illustrated in FIG. 5. By this state, the operation unit 200 is directly connected with the host PC 50 through the USB interface. Hereafter, the host PC 50 controls the operation unit 200 on the printer 10. Internal processing of each of the host PC 50 and the printer 10 in this sequence will be described below referring to a flowchart.

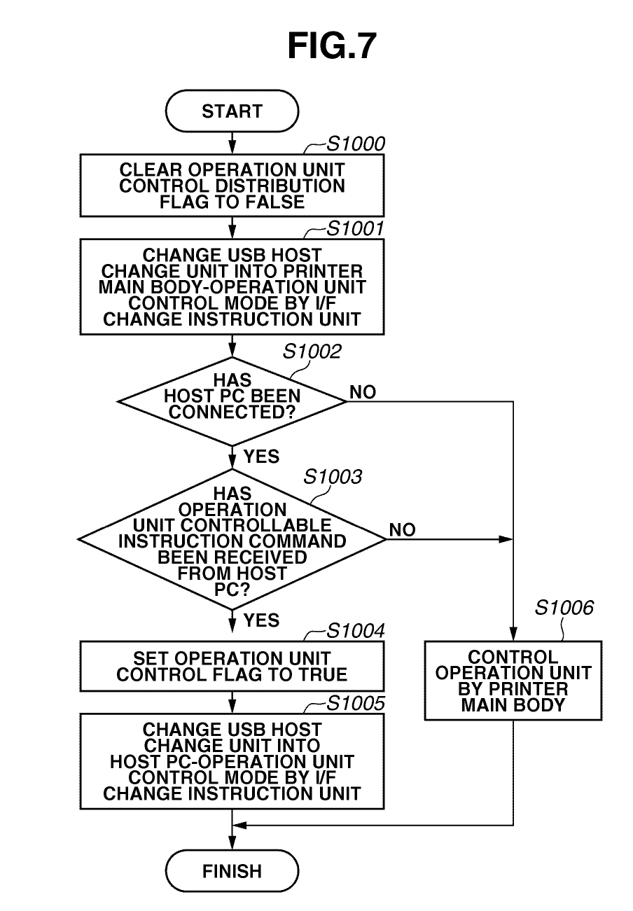

FIG. 7 is a flowchart illustrating processing flow to change an operation unit control mode. FIG. 7 illustrates the content of processing inside the printer in the sequence illustrated in FIG. 6. A program which indicates the processing flow in FIG. 7 is stored in the ROM 1110 on the printer 10. Each step in FIG. 7 is executed by the CPU 1100 on the controller 100 on the printer 10.

In step S1000, the CPU 1100 clears the operation unit control distribution flag 1510 to false. In the initial state of the printer 10, since the printer main body controls the operation unit 200, in the initial state, it is intended that the printer main body-operation unit control mode (first connection state) is always selected. In step S1001, the USB host change instruction unit 1500 changes the connection state of the USB host change unit 1400 into the printer main body-operation unit control mode (first connection state). In other words, it is changed into the connection state illustrated in FIG. 4. It is changed into the USB connection state in which the printer 10 (controller 100) controls the operation unit 200. This step is processing on the printer side corresponding to step st3000 in the sequence illustrated in FIG. 6.

In step S1002, the CPU 1100 determines whether the host PC 50 is connected to determine whether it can communicate with the connected host PC 50 through the USB interface. If it is determined it can communicate with the host PC 50 through the USB interface (YES in step S1002), the processing proceeds to step S1003. On the other hand, if it is not determined it can communicate with the host PC 50 through the USB interface (NO in step S1002), the processing proceeds to step S1006. The CPU 1100 cannot communicate with the host PC 50 when in the first place the host PC 50 and the printer 10 are not connected through the USB interface, or the power source on the host PC 50 is not started up. The processing in step S1002 is one example of a first determination unit.

In step S1003, the CPU 1100 determines whether the operation unit controllable instruction command is received from the host PC 50 via the USB interface cable 30. In other words, the CPU 1100 determines whether the host PC 50 can control the operation unit 200. If it is determined that the operation unit controllable instruction command is received (YES in step S1003), since the host PC 50 can control the operation unit 200, the processing proceeds to step S1004. On the other hand, if the operation unit controllable instruction command is not received (NO in step S1003), since the host PC 50 cannot control the operation unit 200, the processing proceeds to step S1006. While a determination is YES in step S1002, determination is NO in step S1003 when the host PC 50 connected to the printer 10 is not equipped with the operation unit driver 900 for controlling the operation unit 200. This step is processing on the printer side corresponding to step st3001 in the sequence illustrated in FIG. 6. The processing in step S1003 is processing which is one example of a second determination unit.

In step S1004, the CPU 1100 sets the operation unit control distribution flag 1510 to true. Since the host PC 50 can control the operation unit 200, this is intended so as to select the host PC-operation unit control mode (second connection state). In step S1005, the USB host change instruction unit 1500 changes the connection state of the USB host change unit 1400 into the host PC-operation unit control mode (second connection state). In other words, it is changed into the connection state described in FIG. 5. It is changed into the USB connection configuration such that the host PC 50 controls the operation unit 200. This step is processing on the printer side corresponding to step st3002 in the sequence illustrated in FIG. 6.

In step S1007, since the connection state of the USB host change unit 1400 remains the printer main body-operation unit control mode (first connection state), hereafter, an operation is executed in a state in which the printer 10 (controller 100) controls the operation unit 200.

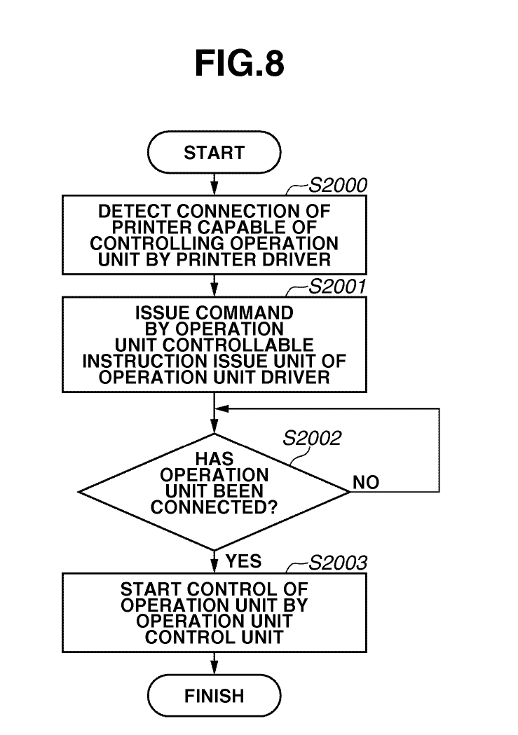

FIG. 8 is a flowchart illustrating the operation of the host PC according to the present exemplary embodiment. FIG. 8 illustrates the content of processing on the host PC 50 side in the sequence illustrated in FIG. 6. A program which indicates processing flow in FIG. 8 is stored in the ROM 502 or the HDD 504 on the host PC 50. Each step in FIG. 8 is executed by the CPU 501 on the controller 500 on the host PC 50.

In step S2000, when the printer driver 800 detects connection of a printer configured to control an operation unit, the printer driver 800 notifies the operation unit driver 900 that the printer to be controlled by the operation unit is connected. A USB includes product information for each individual device and can identify the device. The device information is stored in the ROM 1110 on the printer 10 and is notified to the host PC 50 along with start of communication through the USB interface. This step is processing on the host PC side corresponding to step st3000 in the sequence illustrated in FIG. 6.

In step S2001, the operation unit controllable instruction issue unit 910 on the operation unit driver 900 transmits an operation unit controllable instruction command to the printer 10. This step is processing on the host PC side corresponding to step st3001 in the sequence illustrated in FIG. 6.

In step S2002, the CPU 501 determines whether the operation unit 200 is connected to the host PC 50 through the USB interface. More particularly, it is determined whether the connection state of the USB host change unit 1400 equipped on the printer 10 is changed into the second connection state. On the other hand, if the operation unit 200 is not connected to the host PC 50 through the USB interface (NO in step S2002), the processing stands by.

If the CPU 501 determines that the operation unit 200 is connected to the host PC 50 through the USB interface (YES in step S2002), the processing proceeds to step S2003. Hereafter, the operation unit driver 900 on the host PC 50 controls the operation unit 200. This step is processing on the host PC side corresponding to the step after step st3002 in the sequence illustrated in FIG. 6.

As described above, according to the present exemplary embodiment, when the host PC 50 includes the operation unit driver 900, the host PC 50 and the operation unit 200 are directly connected through the USB interface without passing through the printer 10 (controller 100 on printer 10). This allows a host PC to directly control an operation unit. At this time, a problem of a bottleneck that occurs when passing through a printer (controller on printer), can be solved.

In the present exemplary embodiment, a printer has been described as an example of an image forming apparatus to be connected with a host PC through a USB interface. However, the embodiments can also be applied to other image forming apparatuses such as a copying machine, a multifunction peripheral, and a scanner. Further, as an example of an external device for controlling an operation unit on an image forming apparatus, a host PC has been described. However, the embodiments can be applied to all information processing apparatuses containing a host PC.

Furthermore, in the present exemplary embodiment, the operation unit 200 on the printer 10 has been described as a hardware unit incorporated in the printer 10. However, it may also be configured so as to be connected to the outside of the printer 10 through a USB interface.

### Other Embodiments

The embodiments can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium). In an example, a storage medium, such as a computer-readable medium, may store a program that causes an image forming apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-292837 filed Dec. 24, 2009, which is hereby incorporated by reference herein in its entirety.

What is claimed is:

1. An image forming apparatus to communicate through a universal serial bus (USB) interface with an information processing apparatus and an operation unit, the image forming apparatus comprising:
a change unit configured to change a connection state between a state in which the image forming apparatus as a USB host is connected to the operation unit as a USB device and a state in which the information processing apparatus as a USB host is connected to the operation unit as a USB device;
a first determination unit configured to determine whether it is possible to communicate with the information processing unit through the USB interface; and
a second determination unit configured to determine whether the information processing apparatus can control the operation unit, wherein when both the first determination unit determines it is possible to communicate with the information processing unit through the USB interface and the second determination unit determines that the information processing apparatus can control the operation unit, the change unit changes a first connection state in which the image forming apparatus as a USB host is connected to the operation unit as a USB device to a second connection state in which the information processing apparatus as a USB host is connected to the operation unit as a USB device.

2. The image forming apparatus according to claim 1, wherein the first connection state is a state in which both the image forming apparatus as a USB host is connected to the operation unit as a USB device and the information processing apparatus as a USB host is connected to the image forming apparatus as a USB device, and
wherein the second connection state is a state in which both the information processing apparatus as a USB host is connected to the operation unit as a USB device and the information processing apparatus as a USB host is connected to the image forming apparatus as a USB device.

3. The image forming apparatus according to claim 1, further comprising: a receiving unit configured to receive information indicating that the operation unit can be controlled from the information processing apparatus through a USB interface,
wherein when the information is received by the receiving unit, the second determination unit determines that the information processing apparatus can control the operation unit.

4. The image forming apparatus according to claim 1, wherein when the second determination unit does not determine that the information processing apparatus can control the operation unit, the change unit does not change the first connection state to the second connection state even if the first determination unit determines it is possible to communicate with the information processing unit through the USB interface.

5. The image forming apparatus according to claim 1, wherein the operation unit is incorporated in the image forming apparatus and includes a display unit configured to display a state of the image forming apparatus.

6. A method for controlling an image forming apparatus to communicate through a universal serial bus (USB) interface with an information processing apparatus and an operation unit, the method comprising:
changing a connection state between a state in which the image forming apparatus as a USB host is connected to the operation unit as a USB device and a state in which the information processing apparatus as a USB host is connected to the operation unit as a USB device; and
having a first determination unit configured to determine whether it is possible to communicate with the information processing unit through the USB interface and a second determination unit configured to determine whether the information processing apparatus can control the operation unit, wherein when both the first determination unit determines it is possible to communicate with the information processing unit through the USB interface and the second determination unit determines that the information processing apparatus can control the operation unit, the change unit changes a first connection state in which the image forming apparatus as a USB host is connected to the operation unit as a USB device to a second connection state in which the information processing apparatus as a USB host is connected to the operation unit as a USB device.

7. A storage medium storing a program that causes a computer to execute a control method according to claim 6.
